(19) United States
(12) Patent Application Publication
(10) Pub. No.: US 2025/0148316 A1
(43) Pub. Date: May 8, 2025

(54) INFERENCE APPARATUS, INFERENCE METHOD, AND STORAGE MEDIUM

(71) Applicant: NEC Corporation, Minato-ku, Tokyo (JP)

(72) Inventors: Genki KUSANO, Tokyo (JP); Masafumi OYAMADA, Tokyo (JP); Kunihiro TAKEOKA, Tokyo (JP)

(73) Assignee: NEC Corporation, Minato-ku, Tokyo (JP)

(21) Appl. No.: 18/832,227

(22) PCT Filed: Jan. 31, 2022
(86) PCT No.: PCT/JP2022/003535

§ 371 Date: Jul. 23, 2024

(51) Int. Cl. G06N 5/04; G06F 16/80

(52) U.S. Cl. CPC G06N 5/04; G06F 16/80

(57) ABSTRACT

In order to apply a text-based label inference approach to infer a label to be assigned to target data in a common data form, an inference apparatus (1) includes: a data converting section (11) for converting target data subject to label assignment into text; and a label inferring section (12) for inferring a label to be assigned to the target data, in accordance with a label inference model for inferring a label to be assigned to text and the text obtained by the converting carried out by the data converting means.

### TECHNICAL FIELD

The present invention relates to an inference apparatus, etc. for inferring a label to be assigned to target data.

### BACKGROUND ART

These days, large amounts of data on various contents are collected and accumulated, and a technique for automatically assigning a label to such data is needed correspondingly. For example, Non-Patent Literature 1 below discloses a technique for automatically associating a label with a piece of text by an approach called zero-shot classification.

More specifically, according to the technique of Non-Patent Literature 1, a premise sentence is generated from text subject to classification, and a hypothesis sentence related to a label of a class candidate is also generated. Thereafter, by inputting the generated premise sentence and hypothesis sentence to an entailment model, a degree to which the label is true for the text subject to classification is judged. The entailment model is a model constructed by machine learning of whether the premise sentence entails the hypothesis sentence, i.e. whether the premise sentence and the hypothesis sentence contain the same content.

### CITATION LIST

### Non-Patent Literature

### [Non-patent Literature 1]

Wenpeng Yin, Jamaal Hay, Dan Roth, “Benchmarking Zero-shot Text Classification: Datasets, Evaluation and Entailment Approach”, EMNLP/IJCNLP (1) 2019:3912-3921

### SUMMARY OF INVENTION

### Technical Problem

The zero-shot classification enables automatic labeling of text. However, this technique only makes it possible to perform labeling on text. For example, with the zero-shot classification, it is impossible to label data which is in tabular form. An example aspect of the present invention has been made in view of the above problem, and an example object thereof is to provide an inference apparatus, etc. which make it possible to apply a text-based label inference approach to infer a label to be assigned to target data in a common data form.

### Solution to Problem

An inference apparatus in accordance with an example aspect of the present invention includes: a data converting means for converting target data subject to label assignment into text; and a label inferring means for inferring a label to be assigned to the target data, in accordance with a label inference model for inferring a label to be assigned to text and the text obtained by the converting carried out by the data converting means.

An inference method in accordance with an example aspect of the present invention includes: at least one processor converting target data subject to label assignment into text; and the at least one processor inferring a label to be assigned to the target data, in accordance with a label inference model for inferring a label to be assigned to text and the text obtained by the converting.

An inference program in accordance with an example aspect of the present invention causes a computer to function as: a data converting means for converting target data subject to label assignment into text; and a label inferring means for inferring a label to be assigned to the target data, in accordance with a label inference model for inferring a label to be assigned to text and the text obtained by the converting carried out by the data converting means.

### Advantageous Effects of Invention

An example aspect of the present invention makes it possible to apply a text-based label inference approach to infer a label to be assigned to target data in a common data form.

### BRIEF DESCRIPTION OF DRAWINGS

FIG. 1 is a block diagram illustrating a configuration of an inference apparatus in accordance with a first example embodiment of the present invention.

FIG. 2 is a flowchart illustrating a flow of an inference method in accordance with the first example embodiment of the present invention.

FIG. 3 is a representation of an example of assigning labels to pieces of target data in different forms.

FIG. 4 is a block diagram illustrating a configuration of an inference apparatus in accordance with a second example embodiment of the present invention.

FIG. 5 is a representation of examples of conversion rules applied in a case where target data is structured data.

FIG. 6 is a representation of an example of adding text generated from metadata to text generated from target data.

FIG. 7 is a representation of examples of conversion rules applied to pieces of target data which are linked together by ER.

FIG. 8 is a representation of an example of a conversion rule applied to semi-structured data having a hierarchical structure.

FIG. 9 is a representation of an example of a conversion rule applied to semi-structured data in graphical form.

FIG. 10 is a representation of an example of a method for sampling elements related to labels.

FIG. 11 is an explanatory representation of a method for judging, in accordance with the hierarchical structure of labels, whether to incorporate, into the text, column names and elements contained in target data.

FIG. 12 is a flowchart illustrating a flow of processes carried out by the inference apparatuses above.

FIG. 13 is a diagram illustrating an example computer which executes the instructions of a program which is software implementing the functions of each of the apparatuses in accordance with the respective example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### (Configuration of Inference Apparatus)

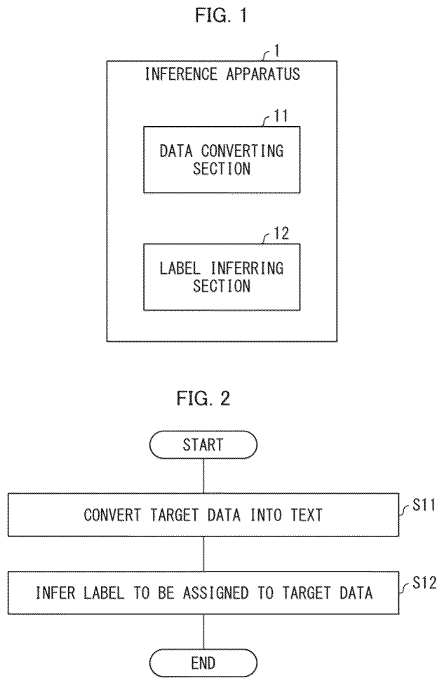

The configuration of an inference apparatus 1 in accordance with the present example embodiment will be described with reference to FIG. 1. FIG. 1 is a block diagram illustrating a configuration of the inference apparatus 1. The inference apparatus 1 includes a data converting section 11 and a label inferring section 12, as illustrated in FIG. 1.

The data converting section 11 converts target data subject to label assignment into text.

The label inferring section 12 infers a label to be assigned to the target data, in accordance with a label inference model for inferring a label to be assigned to text and the text obtained by the converting carried out by the data converting section 11.

As above, a configuration adopted in the inference apparatus 1 in accordance with the present example embodiment is the configuration in which a data converting section 11 and a label inferring section 12 are included, the data converting section 11 converting target data subject to label assignment into text, the label inferring section 12 inferring a label to be assigned to the target data, in accordance with a label inference model for inferring a label to be assigned to text and the text obtained by the converting carried out by the data converting section 11. With this configuration, it is possible to apply a text-based label inference approach to infer a label to be assigned to target data in a common data form.

### (Inference Program)

The above functions of the inference apparatus 1 can be implemented by a program. An inference program in accordance with the present example embodiment causes a computer to function as: a data converting means for converting target data subject to label assignment into text; and a label inferring means for inferring a label to be assigned to the target data, in accordance with a label inference model for inferring a label to be assigned to text and the text obtained by the converting carried out by the data converting means. With this inference program, it is possible to apply a text-based label inference approach to infer a label to be assigned to target data in a common data form.

### (Flow of Inference Method)

A flow of an inference method in accordance with the present example embodiment will be described below with reference to FIG. 2. FIG. 2 is a flowchart illustrating a flow of the inference method. It should be noted that the steps of this inference method may be carried out by a processor included in the inference apparatus 1, may be carried out by a processor included in another apparatus, or may be carried out by respective processors provided in different apparatuses.

In S11, at least one processor converts target data subject to label assignment into text.

In S12, the at least one processor infers a label to be assigned to the target data, in accordance with a label inference model for inferring a label to be assigned to text and the text obtained by the converting.

As above, the inference method in accordance with the present example embodiment includes: at least one processor converting target data subject to label assignment into text; and the at least one processor inferring a label to be assigned to the target data, in accordance with a label inference model for inferring a label to be assigned to text and the text obtained by the converting. With this inference method, it is possible to apply a text-based label inference approach to infer a label to be assigned to target data in a common data form.

### Second Example Embodiment

The following description will discuss a second example embodiment of the present invention in detail with reference to the drawings.

### (Outline of Inference Method)

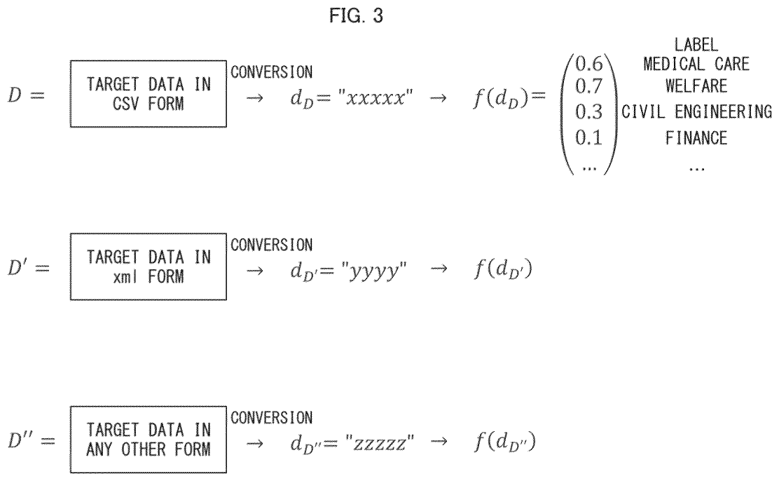

The outline of an inference method (hereinafter, referred to as the present method) in accordance with the present example embodiment will be described below, with reference to FIG. 3. FIG. 3 is a representation of an example of assigning labels to pieces of target data in different forms. Specifically, presented in FIG. 3 as examples of target data subject to label assignment are three examples which are: target data D in comma separated values (CSV) form; target data D′ in XML form; and target data D″ in any other form. The any other form may be a form without a structure (e.g. a still image, a moving image, or voice). That is, the target data D″ may be unstructured data. In the example of FIG. 3, candidates for labels to be assigned to these pieces of target data are, for example, medical care, welfare, civil engineering, and finance.

In the present method, first of all, target data is converted into text. A method for conversion into text according to the data form of target data is ready, and by applying the method, it is possible to convert target data into text with respect to different forms taken by the target data. This will be described later in detail. In the example of FIG. 3, target data D is converted into text which is d_{D}=“xxxxx”. Similarly, D′ is converted into text which is d_{D′}=“yyyy”, and D″ is converted into text which is d_{D″}=“zzzzz”.

Next, in the present method, the text generated by the above conversion is inputted to a label inference model for inferring a label to be assigned to text. This leads to output of an output value (hereinafter, referred to as a goodness-of-fit score) which indicates the degree of fitness between each label and text. The goodness-of-fit score indicates a degree to which a label is true for target data on which text is based, i.e. a degree to which the possibility that it is appropriate to assign the label to the target data is high. The label inference model in the example of FIG. 3 is a score function f, and by inputting the text d_{D} to this score function f, the goodness-of-fit score ranging from 0 to 1 is calculated for each of the labels such as medical care, welfare, civil engineering, and finance.

This goodness-of-fit score being closer to 1 indicates that the fitness is higher, i.e., the possibility that this label is an appropriate label to be assigned to the target data D is higher. Thus, it can be understood from the goodness-of-fit score f(d_{D}) illustrated in FIG. 3 that the target data D should be assigned labels such as medical care with a goodness-of-fit score of 0.7 and welfare with a goodness-of-fit score of 0.6, but should not be assigned a label of civil engineering with a goodness-of-fit score of 0.3 or finance with a goodness-of-fit score of 0.1. The goodness-of-fit score only needs to indicate the fitness between each label and target data, and is not limited to the example illustrated. For example, a value normalized such that the sum of the goodness-of-fit scores of respective labels is 1 may be used as the goodness-of-fit score.

Since like the target data D, each of the target data D′ and the target data D″ is converted into text, it is possible to calculate the goodness-of-fit score thereof by applying the same score function f that is applied to the target data D. Further, it is possible to infer labels to be assigned to each of the target data D′ and the target data D″ in accordance with the calculated goodness-of-fit scores.

As above, with the present method, it is possible to apply a text-based label inference approach to infer a label to be assigned to target data in a common data form. In addition, with the present method, not only the trouble of preparing individual label inference models according to forms taken by target data is eliminated, but it is also possible to use a single evaluation standard which is a single label inference model, to evaluate, for each of pieces of target data in different forms, the fitness between that piece of target data and each label.

### (Configuration of Inference Apparatus)

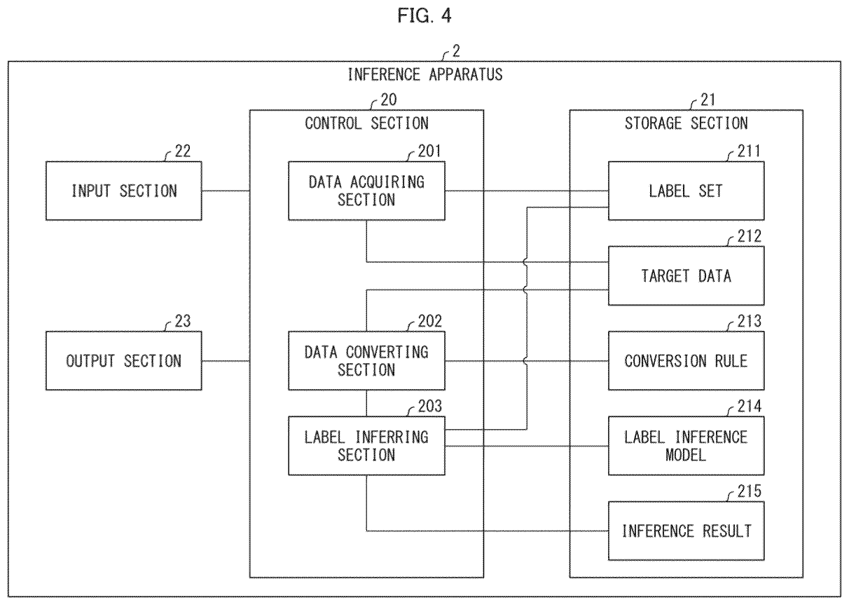

A configuration of an inference apparatus 2 in accordance with the present example embodiment will be described below on the basis of FIG. 4. FIG. 4 is a block diagram illustrating a configuration of the inference apparatus 2. The inference apparatus 2 is an apparatus for inferring a label to be assigned to target data, and includes: a control section 20 for performing centralized control of the sections of the inference apparatus 2; and a storage section 21 which is storage in which to store various kinds of data used by the inference apparatus 2, as illustrated. The inference apparatus 2 further includes: an input section 22 for accepting a user's operation of input to the inference apparatus 2; and an output section 23 via which the inference apparatus 2 outputs data. The inference apparatus 2 may be an apparatus exclusively for label inference, or may be a general-purpose apparatus which can be used for any other uses.

The control section 20 includes a data acquiring section 201, a data converting section (data converting means) 202, and a label inferring section 203 (label inferring means). The storage section 21 has stored therein a label set 211, target data 212, conversion rules 213, a label inference model 214, and an inference result 215.

The data acquiring section 201 acquires target data subject to label assignment and a label set which includes candidates for a label to be assigned to the target data. The data acquiring section 201 stores in the storage section 21 the acquired label set as the label set 211, and also stores in the storage section 21 the acquired target data as the target data 212.

The label set 211 is represented as C={c₁, c₂, . . . c_{K}}. Each of the elements of the label set 211 is a character string (e.g. a word and text). The number K of labels is any number, and may be such that K=1, or may be such that K≥2. The label set 211 may be defined by a user, or a well-known public classification scheme may be applied as the label set 211.

The data converting section 202 converts the target data 212 subject to label assignment into text. Specifically, the data converting section 202 uses a conversion rule 213 to convert the target data 212 to text. The details of the conversion rule 213 will be described later. Given that data D is the target data, the data converting section 202 receives the data D as an input and outputs the following text set.
{d_{D}¹, . . . d_{D}ⁿ}
   Note that the data converting section 202 may use a single conversion rule 213 to generate a piece of text from a piece of target data 212, or may use a plurality of conversion rules 213 to generate a plurality of pieces of text from a piece of target data 212.

The label inferring section 203 infers a label to be assigned the target data, in accordance with an output value which is obtained by inputting, to the label inference model 214 for inferring a label to be assigned to text, the text obtained by the conversion carried out by the data converting section 202, i.e. in accordance with the above-described goodness-of-fit score. A result of this inference is stored in the storage section 21 as the inference result 215. Note that the label inferring section 203 may infer a single label to be assigned to a piece of target data, or may infer a plurality of labels to be assigned to a piece of target data. The inference of a label to be assigned to target data can be read as target data classification.

The label inference model 214 may be the above-described score function f. The score function f is a function which outputs, upon input of the text d_{D} and a label set C, goodness-of-fit score of the respective labels. In a case where the score function f is used, the label inferring section 203 uses the text d_{D} generated by the data converting section 202 and the label set C acquired by the data acquiring section 201, to calculate a goodness-of-fit score vector f(d_{D}), which indicates the goodness-of-fit scores of the respective labels.

The label inference model 214 only needs to be capable of calculating a goodness-of-fit score which indicates the fitness between a label and target data. For example, a known text classification model such as a zero-shot text classifier as described in Non-Patent Literature 1 may be applied as the label inference model 214. The zero-shot text classifier described in Non-Patent Literature 1 is a model which associates a classification target sample with a premise sentence and associates a label with a hypothesis sentence, and judges whether the premise sentence entails the hypothesis sentence, to judge a class to which the sample is assigned.

Here is a description of the zero-shot text classifier. Zero-shot text classification is the technique for, in text classification, classifying text as a class which is not contained in training data. Assume, for example, that a label of “entertainment” or “politics” is assigned to text contained in training data. Judging, under this assumption, whether text subject to inference is classified as a class of “economics”, which is not contained in the training data, is the zero-shot text classification. An example of the zero-shot text classifier is a method of using a language understanding model constructed by learning of whether a premise sentence entails a hypothesis sentence, as described above. The following is a description of the method.

In a case where the zero-shot text classifier as described above is used as the label inference model 214, the label inferring section 203 generates a hypothesis sentence related to a label of a class candidate. The hypothesis sentence related to the label can be generated with use of a known approach which is, for example, embedding the character string of the label into a predetermined template. The label inferring section 203 then inputs, to the zero-shot text classifier, text generated by the data converting section 202 from the target data and the generated hypothesis sentence, to calculate a goodness-of-fit score which indicates a degree to which the label is true for the target data. Note that instead of the text generated by the data converting section 202, a premise sentence generated by subjecting the text to further processing (e.g. summarizing) may be inputted to the zero-shot text classifier.

As above, the label inferring section 203 may infer a label to be assigned to target data, in accordance with a degree to which the text generated by the data converting section 202 entails a hypothesis sentence related to a label of a class candidate, the degree being indicated by a goodness-of-fit score calculated with use of a language understanding model constructed by learning of whether a premise sentence entails a hypothesis sentence. This configuration provides an example effect of making it possible to infer a label to be assigned to target data from among a label set which contains unlearned unknown label, in addition to the example effect produced by the inference apparatus 1 in accordance with the first example embodiment.

Note that the zero-shot classifier is not limited to the above example, but classifiers such as a padding-based classifier using a large language model which is, for example, the generative pre-trained transformer-3 (GPT-3) and a question answering model-based classifier can be applied. These classifiers are disclosed in, for example, the following literature.
Ruiqi Zhong et al., Adapting Language Models for Zero-shot Learning by Meta-tuning on Dataset and Prompt Collections, EMNLP 2021 Findings. https://aclanthology.org/2021.findings-emnlp.244/

Further, a trained model constructed by machine learning of a relationship between data and a label to be assigned to the data may be used as the label inference model 214. Furthermore, a model obtained by additionally training a known text classification model with use of independently-collected data may be used as the label inference model 214. The data independently collected is preferably data related to target data which is desired to be assigned a label.

A method for inferring a label to be assigned to target data in accordance with a goodness-of-fit score is any method. As an example, the label inferring section 203 may infer labels to be assigned to target data, the labels being labels which are contained in the label set and which have goodness-of-fit scores not smaller than a threshold. As another example, the label inferring section 203 may infer labels to be assigned to target data, the labels being a predetermined number of labels which are contained in the label set and which have higher-ranked goodness-of-fit scores in the label set. The label inferring section 203 may then store information as the inference result 215, the information indicating each of the inferred labels.

As above, a configuration adopted in the inference apparatus 2 in accordance with the present example embodiment is the configuration in which a data converting section 202 and a label inferring section 203 are included, the data converting section 202 converting the target data 212 subject to label assignment into text, the label inferring section 203 inferring a label to be assigned to the target data, in accordance with a label inference model 214 for inferring a label to be assigned to the text and the text obtained by the converting carried out by the data converting section 202. More specifically, the inference of a label is carried out in accordance with an output value obtained by inputting, to the label inference model 214, the text obtained by the converting carried out by the data converting section 202. This configuration provides an example effect of making it possible to apply a text-based label inference approach to infer a label to be assigned to target data in a common data form. In addition, it is not necessary to prepare a label inference model for each of the data forms (e.g. a table, an image, text) of target data, and it is possible to use a single label inference model 214 to infer a label to be assigned to target data with respect to the plurality of data forms taken by the target data.

### (Example of Conversion Rule Applied to Structured Data)

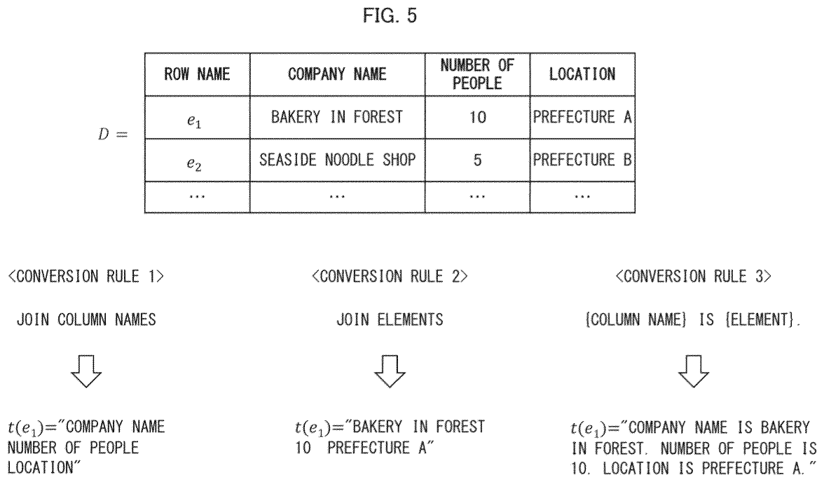

FIG. 5 is a representation of examples of the conversion rules 213 applied in a case where target data is structured data. Structured data is data which has a structure determined in advance and which can be handled in a relational data base management system (RDBMS). For example, data represented as a table defined by rows and columns, as data in a CSV form, is structured data.

The target data D illustrated in FIG. 5 is structured data which contains four columns which are a row name, a company name, the number of people, and a location and in which information (i.e. the element of each column) on each of the row name, the company name, the number of people, and the location is indicated for each of the rows. As examples of the conversion rules 213 used for converting the structured data in such a form into text, conversion rules 1 to 3 are indicated in FIG. 5.

The conversion rule 1 is to join column names together.

A template for generating text in which the column names are joined together can be stored in the storage section 21 as the conversion rule 213. In this example, text obtained by converting a row e via a template t is represented as t(e). As illustrated in FIG. 5, with use of the template t of the conversion rule 1, text of t(e₁)=“company name·number of people·location” is generated from the target data D.

The template used for conversion into text only needs to allow generation of text from elements contained in target data. The template used for conversion into text can also be said to be a conversion rule which indicates what elements contained in target data are disposed and how the elements are disposed, to carry out the conversion into text. The template used for conversion into text is designed so as to allow character strings contained in target data to be embedded therein, as is the above-described template t, and may be a template via which the target data is converted into text by embedding the character strings contained in the target data in the template.

The conversion rule 2 is to join the elements of respective rows together. A template for generating text in which the elements of respective rows are joined together can also be stored in the storage section 21 as the conversion rule 213. As illustrated in FIG. 5, with use of the template t of the conversion rule 2, text of t(e₁)=“BAKERY IN FOREST·10·PREFECTURE A” is generated from the target data D. Similarly, pieces of text of the row name e₂ and the subsequent row names can also be generated. By joining together the pieces of text thus generated, a piece of text d_{D}=“t(e₁)t(e₂) . . . ” is generated from the piece of target data D.

The conversion rule 3 is to convert target data into text which reads “{column name} is {element}.”. Such a template can be stored in the storage section 21 as the conversion rule 213. As illustrated in FIG. 5, with use of the template t of the conversion rule 3, the text of t(e₁)=“Company name is BAKERY IN FOREST. Number of people is 10. Location is PREFECTURE A.” is generated from the target data D. Similarly, pieces of text of the row name e₂ and the subsequent row names can also be generated.

Further, the data converting section 202 may convert the target data into the text of “{column name} {element}”, which is a simple placement of the column name and the element, instead of “{column name} is {element}.”. Further, the data converting section 202 may convert target data into text with use of a conversion rule which generates a phrase concerning the column name and the element, the phrase being different from those of the examples of FIG. 5, such as “{column name} is relates to {element}.”.

It should be noted that the data converting section 202 does not necessarily need to convert all the column names and elements contained in the target data D into text. For example, optionally, the data converting section 202 does not convert an element which satisfies a predetermined condition into text. Examples of the predetermined condition include: being numerical data; containing a missing value; and not having a clear meaning in itself as an identification (ID) number and a symbol. In a case where an element which is numerical data is not converted into text, when the target data D is inverted into text with use of the conversion rule 3, text thus obtained is “Company name is BAKERY IN FOREST. Location is PREFECTURE A”.

Whether the generated text accurately represents the content of target data can depend on the combination of target data and a conversion rule and the column and the element which are subject to conversion. As an example, experience shows that in a case of elements which are numerical values only, conversion of such elements into text do not result in accurate representation of the content of target data. As another example, experience further shows that in a case where the column name is a blank or an identification number, conversion into text with use of elements often results in accurate representation of the content of target data.

Thus, the data converting section 202 may generate a plurality of pieces of text from a piece of target data D. For example, the data converting section 202 may generate a text of d_{D}¹=“company name·number of people·location” with use of the conversion rule 1 and also generate a text of d_{D}²=“Company name is BAKERY IN FOREST. Number of people is 10. Location is PREFECTURE A.” with use of the conversion rule 3. In a case where a plurality of pieces of text are generated from a piece of target data D, the label inferring section 203 aggregates goodness-of-fit scores calculated with use of the respective pieces of text, and then infers a label to be assigned to the target data D. This will be described in detail later in “Aggregation of goodness-of-fit scores”.

The conversion rule 213 may be a conversion model constructed by learning of a correspondence relationship between structured data and text which indicates the content of the structured data. A conversion model to be applied may be an existing model such as Table-to-Text, or may be a model constructed with use of a labeled training data. Further, this conversion model may be generated by unsupervised learning.

### (Utilization of Metadata)

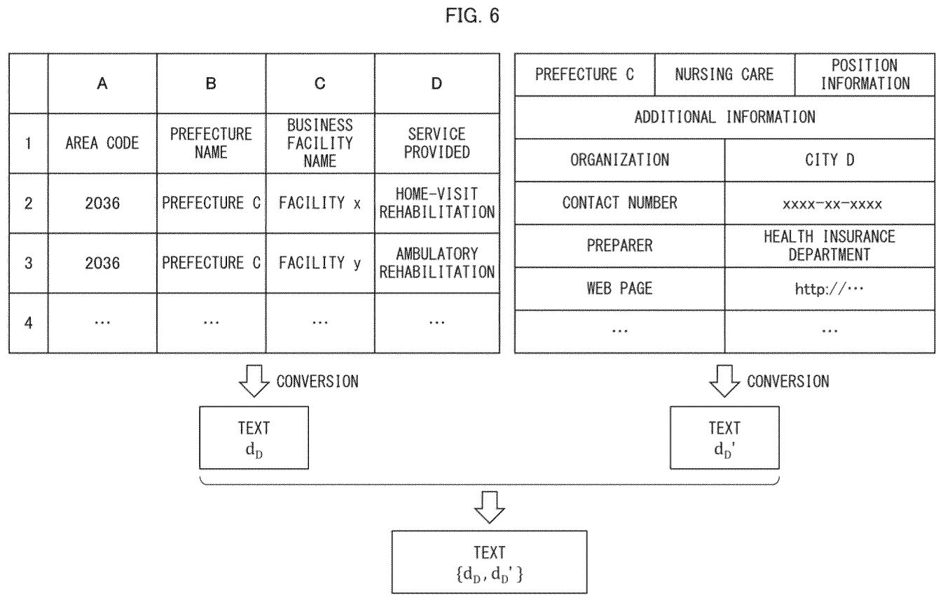

In a case where target data is accompanied by metadata which is related to the target data, the data converting section 202 may add text generated from the metadata to text generated from the target data. This will be described below on the basis of FIG. 6. FIG. 6 is a representation of an example of adding text generated from metadata to text generated from target data.

Illustrated in FIG. 6 are target data which is in tabular form and which contains columns A to D and metadata accompanying the target data. The data converting section 202 can use the conversion rule 213 as described above, to generate the text d_{D} from the target data in tabular form.

In addition, the data converting section 202 generates text d_{D′} from the metadata. In a case where the metadata is structured data, the text d_{D′} is generated with use of the conversion rule 213 for structured data. For example, the “additional information” part of the metadata illustrated in FIG. 6 can be converted with use of the conversion rule of “{column name} is {element}.” into text which is, for example, “Organization is CITY D. Contact number is XXXX-XX-XXXX. Preparer is HEALTH INSURANCE DEPARTMENT. Web page is http:// . . . .” In a case where the metadata is semi-structured data or an unstructured data in part or in whole, the metadata can be converted into text with use of respective conversion rules for these forms of data. Such conversion rules will be described later.

The data converting section 202 may then join together the text d_{D} and the text d_{D′} generated as described above, to generate text {d_{D}, d_{D′}} as text corresponding to the target data. This makes it possible to take not only target data but also metadata into consideration to infer a label.

### (Example of Conversion Rule Applied to Target Data Linked Together by ER)

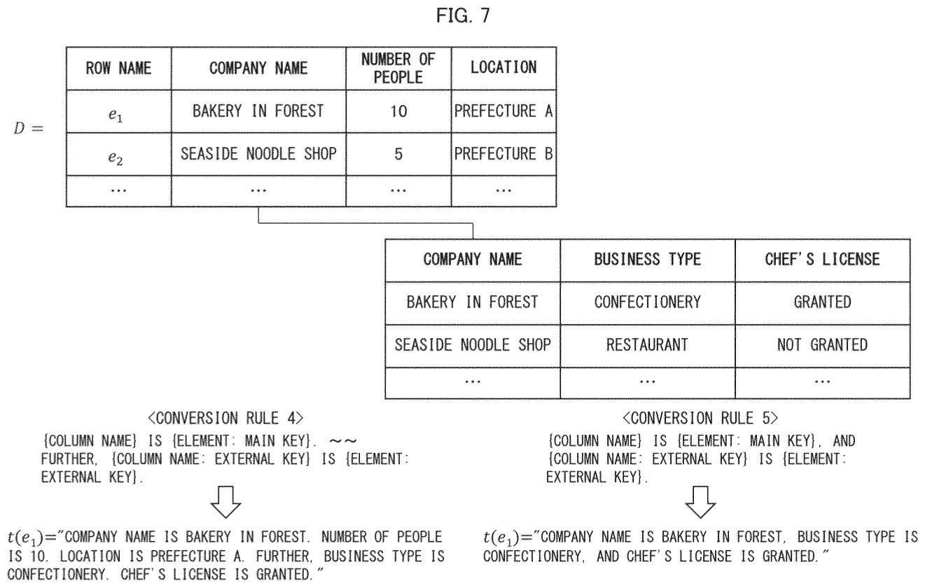

Target data subject to label assignment may be a plurality of tables linked together by ER. Conversion rules applied to this case will be described below on the basis of FIG. 7. FIG. 7 is a representation of examples of conversion rules applied to pieces of target data which are linked together by ER.

Illustrated in FIG. 7 are target data D and conversion rules 4 and 5. In the target data D, a table containing three main keys which are a row name, a company name, the number of people, and location, and a table containing three external keys which are a company name, a business type, and a chef's license are linked together by ER. The conversion rules 4 and 5 are applicable to such target data D.

The conversion rule 4 is to convert respective tables into pieces of text with use of the conversion rules illustrated in FIG. 5 and joining the pieces of text together, to generate a piece of text from the plurality of tables. Specifically, the conversion rule 4 is a template t which is “{column name} is {element: main key}. Further, {column name: external key} is {element: external key}.”. Note that the “{column name} is {element: main key}” part is repeated a number of time, the number being the number of the main keys. The same applies to the “{column name: external key} is {element: external key}” part.

By applying this template t to the row of e₁, text which is t(e₁)=“Company name is BAKERY IN FOREST. Number of people is 10. Location is PREFECTURE A. Further, business type is CONFECTIONERY. Chef's license is granted.” is generated, as illustrated.

The conversion rule 5 is to embed text related to an external key in the middle of text related to a main key. Specifically, the conversion rule 5 is a template t which is “{column name} is {element: main key}, and {column name: external key} is {element: external key}.”. Note that, regarding the “{column name: external key} is {element: external key}” part, in a case where there are a plurality of external keys, the external keys are listed in the form of “{column name: external key} is {element: external key}, and”.

By applying this template t to the row of e₁, text which is t(e₁)=“Company name is BAKERY IN FOREST, business type is CONFECTIONERY, and chef's license is granted.” is generated, as illustrated. Note that, to this text, text generated from other main keys (number of people and location) may be added.

As above, in a case where the target data is composed of a plurality of tables linked together by ER, the data converting section 202 may generate a piece of text having the contents of the respective tables reflected therein. This makes it possible to take the contents of respective tables into consideration to infer a label.

### (Example of Conversion Rule Applied to Semi-Structured Data Having Hierarchical Structure)

Target data subject to label assignment may be semi-structured data. Semi-structured data is data intermediate between structured data, which has a structure, and unstructured data, which does not have a structure at all, and has a structure which has been determined to some degree, though not completely. Unlike structured data, semi-structured data cannot be expressed in tabular form. However, semi-structured data has a rule for expressing data. For example, data in a form such as JavaScript Object Notation (JSON: registered trademark), Hyper Text Markup Language (HTML), or extensible Markup Language (XML) is semi-structured data.

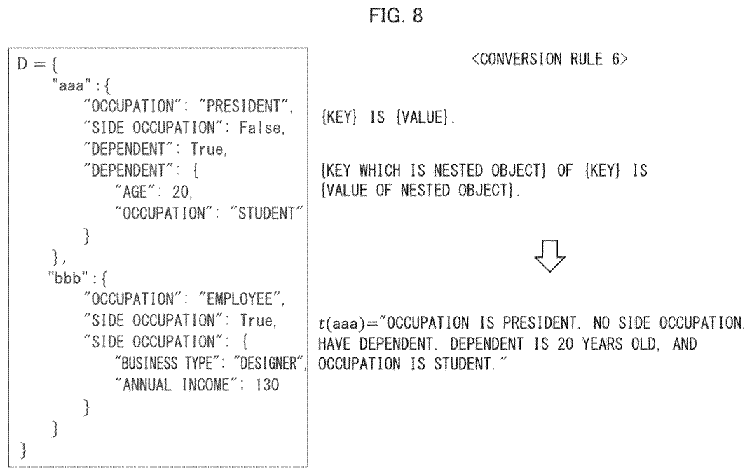

Semi-structured data having a hierarchical structure such as that of JSON form can be converted into text with use of, for example, a conversion rule as illustrated in FIG. 8. FIG. 8 is a representation of an example of a conversion rule applied to semi-structured data having a hierarchical structure. Target data D in JSON form is illustrated in FIG. 8. In JSON form, a key and the value of the key are described in parentheses { }. Further, data regarding the key in parentheses { } can be described in the form of a nested structure (also referred to as a hierarchical structure or a nest) which has additional parentheses { } added thereto.

To such target data D, a conversion rule 6 illustrated in FIG. 8 is applicable. The conversion rule 6 is for generation of text from semi-structured data having a hierarchical structure. Specifically, the conversion rule 6 is to use a template of “{key} is {value}.” and a template of “{key which is nested object} of {key} is {value of nested object}.” to carry out conversion. Note that in a case where target data contains a plurality of sets of a key and a value, the conversion is carried out with use of the template of “{key} is {value}.” for each of the sets. The same applies to the nested object.

When the description regarding “aaa” contained in the target data D illustrated in FIG. 8 is converted with use of this conversion rule 6, text which is t(aaa)=“Occupation is president. No side occupation. Have dependent. Dependent is 20 years old, and occupation is student.” is generated.

In this text, “False” and “True” in the target data D are converted into “No” and “Have”, respectively. In this manner, Boolean values such as “False” and “True” are preferably replaced with appropriate words. Further, in the above text, respective pieces of text corresponding to two nested objects (regarding “dependent”) are joined together via a conjunction “and” to form a single sentence. In this manner, a conversion rule for making text more understandable as a sentence may be additionally used. Such a conversion rule, i.e. a conversion rule for converting a predetermined element (character string) contained in target data into words (character string) corresponding to the element may be stored in the storage section 21 in the form of a table or the like in which, for example, the element and the words are associated with each other. For example, in a case of the above replacement, a correspondence table which is {True: have, False: No} may be stored.

Target data in HTML form or XML form can also be converted into text with use of a similar conversion rule. For example, it is possible for the data converting section 202 to convert target data in HTML form or XML form into text with use of a template which is, for example, “{tag: tag} is {content: content}.”. Further, the {tag} may be converted into a predetermined character string with use of a conversion rule defined in advance. Assume, for example, that target data contains a tag of <title>XX<title>. In this case, the data converting section 202 may convert the “title” part into a character string of “Title” and convert the “<title>XX<title>” part into text of “Title is {XX}.”.

### (Example of Conversion Rule Applied to Semi-Structured Data in Graphical Form)

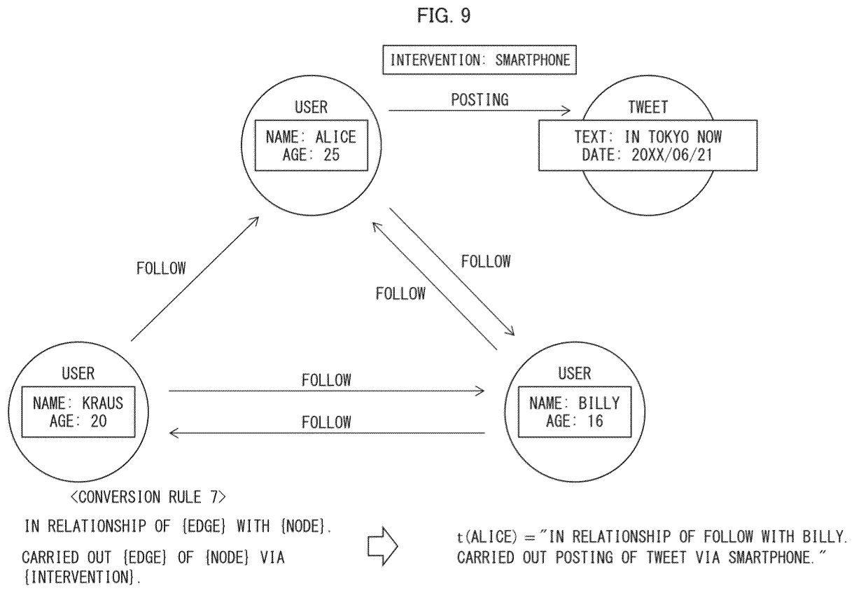

Semi-structured data may be data in graphical form. Semi-structured data in graphical form can be converted into text with use of, for example, a conversion rule as illustrated in FIG. 9. FIG. 9 is a representation of an example of a conversion rule applied to semi-structured data in graphical form. Illustrated in FIG. 9 are a knowledge graph which is semi-structured data in graphical form, and a conversion rule 7 which is applicable to the knowledge graph.

The knowledge graph here refers to data having a structure which includes a plurality of nodes and links connecting the nodes. With the knowledge graph, it is possible to represent a relationship between nodes by a link. For example, in the knowledge graph illustrated in FIG. 9, three users on a social networking service (SNS) and a tweet posted by one of the users are represented as nodes. Further, arrows, i.e. the links connecting the nodes indicate relationships between the users and the relationship between the user and the tweet. It can be read from this knowledge graph that, for example, the user named Alice, 25 years old, is followed by the user named Kraus, 20 years old, and posted the tweet “In Tokyo now” on June 21, 20xx via a smartphone.

In a case where target data is a knowledge graph, a conversion rule for rendering a relationship between nodes as text, such as the conversion rule 7 illustrated in FIG. 9, may be applied. Specifically, the conversion rule 7 is to use a template of “In relationship of {edge} with {node}.” and a template of “Carried out {edge} of {node} via {intervention}.”, to carry out conversion. Note that the “intervention” is information accompanying an edge, and indicates means which intervenes an action indicated by the edge.

When the description of the user “Alice” contained in the knowledge graph illustrated in FIG. 9 is converted with use of this conversion rule 7, text which is t(Alice)=“In relationship of follow with Billy. Carried out posting of tweet via smartphone.” is generated. Note that in this example, the character string of the {node} part is the “name” indicated in the node. In this manner, in a case where a knowledge graph is converted into text, the character string of the {node} part may be a character string related to the node.

Further, also in a case where a knowledge graph is converted into text, a conversion rule for converting a predetermined element (character string) contained in the knowledge graph into words (character string) which correspond to the element may be additionally used. Assume, for example, that information accompanying an edge is not the above {intervention} but {device: smartphone}. In this case, a correspondence table which is, for example, {smartphone: smartphone, device: via} may be stored. With use of this correspondence table and a template of “Carried out {edge} of {node} via {information accompanying edge}.”, it is possible to generate text of “Carried out posting of tweet via smartphone.”.

Further, with the {node} part kept unchanged so as to be a “user”, the data converting section 202 may add text indicating information related to the node, as in the example of ER illustrated in FIG. 7. For example, the data converting section 202 may convert the “In relationship of follow with Billy.” part in the above text into “In relationship of follow with user named Billy, 16 years old.”.

In this manner, information added to a node and a link may also be converted into text. For example, the node “Tweet” in the example of FIG. 9 has added thereto pieces of information which are text indicating the content of the post and a date. The data converting section 202 may use these pieces of information, to generate text of, for example, “Carried out posting of tweet via smartphone, content is “In Tokyo now”, and date is June 21, 20xx.”.

A template having the direction of a link arrow reflected therein may be used. For example, for the node on the end-point side of a link arrow, a template of “In relationship of {edge} with {node}.” may be used, and for the node on the start-point side of the link arrow, a template of “In relationship of being subjected to {edge} by {node}.”. When this template is used to convert the description of the user “Alice” contained in the knowledge graph illustrated in FIG. 7, text of “In relationship of follow with Billy. In relationship of being subjected to follow by Kraus. In relationship of being subjected to follow by Billy.” is generated.

It should be noted that a target which is subject to application of the conversion rule as illustrated in FIG. 9 is not limited to a knowledge graph. For example, an SNS friend graph and the like can also be converted into text with use of a similar conversion rule. Further, the conversion rule 213 used for converting semi-structured data into text may be a conversion model constructed by learning a correspondence relationship between the semi-structured data and text which indicates the content of the semi-structured data. A conversion model to be applied may be an existing model such as json-to-Text or html-to-Text, or may be a model generated with use of a labeled training data. Further, this conversion model may be generated by unsupervised learning.

As above, in a case where target data is semi-structured data, the data converting section 202 uses a predetermined conversion rule 213 for semi-structured data, to convert the target data into text. This configuration makes it possible to convert semi-structured data into appropriate text, and therefore provides an example effect of making it possible to infer a label which has high appropriateness regarding the semi-structured data, in addition to the example effect produced by the inference apparatus 1 in accordance with the first example embodiment.

### (Example of Conversion Rule Applied to Data in any Other Form)

The target data may be data in a form other than the above-described forms, i.e. unstructured data. For example, the target data may be text. In this case, a label may be inferred without conversion. In a case where the text is long, a label may be inferred from text summarized with use of a known document summarization technique. In this case, the document summarization technique is the conversion rule 213.

In a case where the target data is of a portable document format (PDF), the target data may be converted into text with use of a known technique for converting a PDF into text. In this case, the approach for converting a PDF into text is the conversion rule 213. Further, text indicated in a PDF or image data may be read via an optical character reader (OCR) or the like, to be converted into text. In this case, the approach for converting, into text, a character string represented as an image in the PDF or the image data is the conversion rule 213.

In a case where the target data is voice data, the target data may be converted into text with use of a known technique for converting voice data into text. Similarly, in a case where the target data is moving image data, the target data may be converted into text with use of a known video captioning technique for converting moving image data into text. Similarly, in a case where the target data is image data, the target data may be converted into text with use of a known image captioning technique of receiving image data as an input to output explanatory text.

The conversion rule 213 for converting unstructured data into text may be a conversion model constructed by learning of a correspondence relationship between unstructured data and text which indicates the content of the unstructured data.

As above, the data converting section 202 is capable of converting data into text with respect to different forms taken by the data. Thus, by preparing the above-described conversion rules for respective forms taken by target data and storing in the storage section 21 the conversion rules as the conversion rules 213, it is possible for the data converting section 202 to convert target data into text with respect to a plurality of forms taken by the target data.

For example, the data converting section 202 may include a structured data converting section for converting structured data into text, a semi-structured data converting section for converting semi-structured data into text, and an unstructured data converting for converting section unstructured data into text. In this case, the storage section 21 may have stored therein the conversion rule 213 for converting structured data into text, the conversion rule 213 for converting semi-structured data into text, and the conversion rule 213 for converting unstructured data into text. Note that these conversion rules 213 may be templates, or may be conversion models constructed by machine learning. Further, the data converting section 202 may include a template generating section for generating templates as described above.

As above, the data converting section 202 may be designed to be capable of converting target data into text with respect to a plurality of forms taken by the target data. This configuration not only eliminates the trouble of preparing individual label inference models according to forms taken by target data, but also provides an example effect of making it possible to use of a single evaluation standard which is a single label inference model 214, evaluate, for each of pieces of target data in different forms, the fitness between that piece of target data and each label, in addition to the example effect produced by the inference apparatus 1 in accordance with the first example embodiment.

As above, in a case where the target data is data in a predetermined form, the data converting section 202 may convert the target data into text with use of a conversion model constructed by learning of a correspondence relationship between the data in the predetermined form and text which indicates the content of the data in the predetermined form. This configuration enables generation of appropriate text based on the result of the learning, and therefore provides an example effect of making it possible to improve a label inference accuracy, in addition to the example effect produced by the inference apparatus 1 in accordance with the first example embodiment. Note that the data in the predetermined form may be structured data, may be semi-structured data, or may be unstructured data.

### (Sampling Plan)

Whatever form target data may take, the data converting section 202 does not need to convert all the elements of the target data into text, and may sample some elements from the target data to convert the sampled elements into text. For example, in a case where the target data is a single table, the data converting section 202 may sample, on a random basis, some of the rows constituting the target data, to generate text from the sampled rows.

As another example, the data converting section 202 may sample a row which satisfies a predetermined condition such as a condition of not including a missing value. As still another example, the data converting section 202 may perform the sampling depending on the number of unique elements in a column. As used herein, the unique element refers to an element which does not duplicate in one column of table data. Assume, for example, that there are only 47 unique elements in a column of “location” contained in a 1000-line table (target data). This can be true for a case where, for example, the “location” is a column which indicates a prefecture of Japan. In this case, if there is no plan, text which contains many duplicate prefectures would be generated.

In such a case, the data converting section 202 may plan that after conversion of a row containing a certain “Location” into text, any row containing the same “location” would not be converted into text, i.e. would not be sampled. In this manner, the data converting section 202 may perform the sampling such that a plurality of rows which contain the same element are not converted into text. Further, the data converting section 202 may perform the sampling such that the number of rows which contain “location” is not more than an upper limit set in advance. Thus, in a case where the target data is structured data in tabular form, and contains a plurality of rows which contain the same element, the data converting section 202 may sample some of the plurality of rows, which contain the same element, to convert, into text, character strings contained in the sampled rows. This makes it possible to reduce redundancy of generated text, to improve a label inference accuracy.

Assume, for example, that there are 1000 unique elements in one column in a 1000-line table (target data). This can be true for a case where, for example, a column which indicates an ID, a personal name, or the like. IDs and personal names have low power of explaining the content of target data in themselves, and the degree of necessity of incorporating those kinds of information into text is therefore low.

Thus, the data converting section 202 may calculate, for each of the columns of structured data in tabular form, a ratio of the number of unique elements contained in that column to the number of rows of the target data, i.e. a value of (number of unique elements)/(number of rows), and cause the elements of the column having the value not smaller than a threshold to be left out of incorporation into text. This makes it possible to reduce redundancy of generated text, to improve a label inference accuracy.

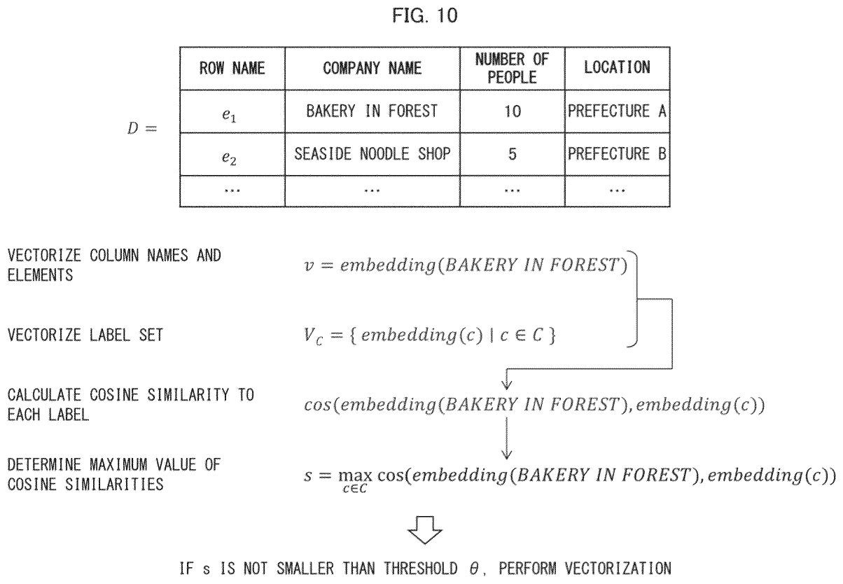

Further, the data converting section 202 may sample an element related to a label, from among elements contained in the target data. This will be described on the basis of FIG. 10. FIG. 10 is a representation of an example of a method for sampling elements related to labels. More specifically, illustrated in FIG. 10 is a method for sampling elements related to the label set C, from among the same target data D as in FIG. 5.

In the method illustrated in FIG. 10, first of all, the data converting section 202 vectorizes column names and elements contained in target data D via a language model, and also vectorizes the labels of the label set via the same language model. The language model used may be any language model capable of generating, from character strings of a column name, an element, and a label, a vector which indicates the feature of the column name, the element, and the label. For example, a known language model, such as bidirectional encoder representations from transformers (BERT) may be used. In FIG. 10, a vector v obtained by vectorizing an element of “BAKERY IN FOREST” contained in the target data D.

Next, the data converting section 202 calculates a cosine similarity between the vector of a column name or an element contained in the target data D and a vector set of each of the labels of the label set. Note that the cosine similarity is a numerical value which indicates a degree to which two vectors are similar to each other, and the cosine similarity cos (v,Vc) between the vector v and a vector V_{c} is (<v,Vc>)/(∥v∥·∥Vc∥).

The data converting section 202 then determines a maximum value s of the cosine similarities calculated with respect to the respective labels of the label set C, and when the maximum value s determined is not smaller than a threshold θ set in advance, converts a row which contains the corresponding column name or element into text. With this configuration, a row which contains a column name or an element which is not related to any of the labels contained in the label set C is not converted into text, and it is therefore possible to reduce redundancy of generated text, to improve a label inference accuracy.

For example, in the example of FIG. 10, the data converting section 202 carries out a process of calculating cosine similarities between the vector v of “BAKERY IN FOREST” and the vector set V_{c} of the labels contained in the label set C.

In a case where the maximum value s of the cosine similarities thus calculated is not smaller than the threshold, it can be said that the element “BAKERY IN FOREST” is related to at least any of the labels contained in the label set. That is, through the above process, it is determined that the character string “BAKERY IN FOREST” contained in the target data D is a character string related to a label. The data converting section 202 therefore converts the target data D into text which contains the character string “BAKERY IN FOREST”. For example, the data converting section 202 may convert the row e₁, which contains the element of “BAKERY IN FOREST”, into text.

In a case where the maximum value s is smaller than the threshold, it can be said that the element “BAKERY IN FOREST” is not related to any of the labels contained in the label set. Thus, in this case, the data converting section 202 does not convert the row e₁, which contains the element “BAKERY IN FOREST”, into text. The data converting section 202 may perform such a process on each of the elements of each of the rows.

Note that the approach for evaluating a link between a column name or an element contained in the target data D and each of the labels of the label set is not limited to the above example, but any approach for evaluating a relatedness or similarity between character strings can be applied.

As above, the data converting section 202 may determine, from among the character strings contained in target data, one or more character strings related to a label, and convert the target data into text which contains the one or more character strings determined. This configuration provides an example effect of making it possible to reduce redundancy of generated text, to improve a label inference accuracy, in addition to the example effect produced by the inference apparatus 1 in accordance with the first example embodiment.

### (Aggregation of Goodness-of-Fit Scores)

As above, a plurality of pieces of text may be generated from a piece of target data D, and the label inferring section 203 may aggregate goodness-of-fit scores calculated with use of the respective pieces of text, to infer a label to be assigned to the target data. That is, the label inferring section 203 may include a score aggregating section for aggregating goodness-of-fit scores calculated with use of respective pieces of text. Described below is a score aggregation method carried out by the score aggregating section.

The goodness-of-fit scores calculated with use of respective pieces of text is a set of goodness-of-fit score vectors, and can be represented as follows.

{f( [symbol] )

[symbol]

Since the term f(d_{D}) is a vector of dimensions of the number of elements of the label set C,

f(d_{D})∈ [symbol] ^{|C|}

the goodness-of-fit score of each label cₖ is denoted as follows.

f(d_{D})[cₖ]∈

[symbol]

In this case, the score aggregating section aggregates the goodness-of-fit scores calculated with use of respective pieces of text, to calculate the following single goodness-of-fit score vector.

f̅(d_{D})∈ [symbol] ^{|C|}

A method for aggregating the goodness-of-fit scores is any method. As an example, the score aggregating section may calculate an arithmetic mean value of the goodness-of-fit scores calculated with use of respective pieces of text. In this case, the goodness-of-fit score vector obtained by the aggregation is represented by Expression (1) below. As another example, the score aggregating section may calculates the maximum value of the goodness-of-fit scores calculated with use of respective pieces of text. In this case, the goodness-of-fit score vector obtained by the aggregation is represented by Expression (2) below.

$$\overline{f} ( {d}_{D} ) := \frac{1}{L} {\sum }_{ℓ = 1}^{L} f ( {d}_{D}^{ℓ} ) ∈ {ℝ}^{\vert C \vert} \qquad ( 1 )$$

$$\overline{f} ( {d}_{D} ) [ {c}_{k} ] := {max}_{ℓ} ( {d}_{D}^{ℓ} ) [ {c}_{k} ] \qquad ( 2 )$$

Assume, for example, that four pieces of text below are generated from the target data D illustrated in FIG. 5 by applying four types of conversion rules.
d_{D}¹=“company name·number of people·location”
d_{D}²=“Company name is BAKERY IN FOREST. Number of people is 10. Location is PREFECTURE A.”
d_{D}³=“Company name is BAKERY IN FOREST. Location is PREFECTURE A.”
d_{D}⁴=“10 5”

Assume additionally that in this case, the goodness-of-fit scores calculated regarding a label of “food and beverage” are as follows.

f(d_{D}¹)[food and beverage]=0.4

f(d_{D}²)[food and beverage]=0.9

f(d_{D}³)[food and beverage]=1.0

f(d_{D}⁴)[food and beverage]=0.2

In this case, the score aggregating section may aggregate these goodness-of-fit scores with use of Expression (1), and a goodness-of-fit score of 0.625 is derived regarding the “food and beverage” label, accordingly. Alternatively, the score aggregating section may exclude an outlier from the plurality of goodness-of-fit scores calculated, and then aggregate these goodness-of-fit scores with use of Expression (1). This makes it possible to obtain the result of aggregation which has reflected therein the goodness-of-fit scores of pieces of text generated with use of conversion rules which are included in a plurality of types of conversion rules and which are considered useful for target data. For example, In a case where values not more than 0.3 are taken as outliers, the score aggregating section may take, as the goodness-of-fit score of the label “food and beverage”, 0.77 which is the arithmetic mean value of f(d_{D}¹) [food and beverage], f(d_{D}²) [food and beverage], and f(d_{D}³) [food and beverage], each of which has a goodness-of-fit score of more than 0.3. Alternatively, the label inferring section 203 may aggregate these goodness-of-fit scores with use of Expression (2), and a goodness-of-fit score of 0.8 is derived regarding the “food and beverage” label, accordingly.

### (Inference of Label)

The label inferring section 203 infers a label to be assigned to the target data, on the basis of the aggregation result as described above. As an example, the label inferring section 203 may infer a label to be assigned to the target data in accordance with the goodness-of-fit score derived by the aggregation and a predetermined threshold θ, as indicated in the following expression.

f̅(d_{D})∈ [symbol] ^{C|}, [symbol] θ∈

[symbol]

In this case, N labels (N is a positive integer not greater than the number K of labels) to be assigned to the target data

ĉ1,ĉ2, . . . ,ĉ_{N}

are outputted. A method for inferring a label to be assigned to target data in accordance with the goodness-of-fit score derived by the aggregation is any method. For example, the label inferring section 203 may infer a label having a goodness-of-fit score not smaller than the threshold θ, as a label to be assigned to the target data, as indicated in Expression (3) below.

$$\overline{f} ( {d}_{D} ) [ {\hat{c}}_{1} ] \geq \overline{f} ( {d}_{D} ) [ {\hat{c}}_{2} ] \geq … \geq \overline{f} ( {d}_{D} ) [ {\hat{c}}_{N} ] \geq θ \qquad ( 3 )$$

As another example, the label inferring section 203 may infer θ labels having higher-ranked goodness-of-fit scores, as labels to be assigned to the target data, as indicated in Expression (4). In this context, θ is a positive integer, and θ=N.

$$\overline{f} ( {d}_{D} ) [ {\hat{c}}_{1} ] \geq \overline{f} ( {d}_{D} ) [ {\hat{c}}_{2} ] \geq … \geq \overline{f} ( {d}_{D} ) [ {\hat{c}}_{θ} ] \qquad ( 4 )$$

As above, in a case where the data converting section 202 converts a piece of target data into a plurality of pieces of text, the label inferring section 203 infers a label to be assigned to the target data in accordance with each of the output values obtained by inputting the respective pieces of text to the label inference model 214. This configuration provides an overall inference result derived from goodness-of-fits between a plurality of respective pieces of text and target data, and therefore provides an example effect of making it possible to make a more robust inference, in addition to the example effect produced by the inference apparatus 1 in accordance with the first example embodiment.

### (Hierarchical Classification)

Although the labels of the label set are arranged flat, i.e. not in a hierarchy in the above example, it is possible to infer a label with use of a hierarchical label set. By using information indicating a hierarchical structure, an improvement in a label inference accuracy can be expected.

In this case, the data acquiring section 201 acquires not only the label set C={c₁, c₂, . . . , c_{K}} but also information indicating the hierarchical structure of the labels. The information indicating the hierarchical structure of the labels may be, for example, an edge set E={eᵢⱼ|cᵢ is the parent category of cⱼ}. With the edge set E, it is also possible to indicate, for example, that a label of “Literature. Review” is the parent category of a label of “Literary work”.

In this case, it is preferable to use, as the label inference model 214, a hierarchical-classification model which returns, upon reception of text d, labels, and the hierarchical structure (C,E) of the labels as inputs, a goodness-of-fit score f(d) for each of the labels. By using such a hierarchical-classification model, it is possible for the label inferring section 203 to calculate the goodness-of-fit score f(d) for each of labels, from the text d that is generated by the data converting section 202 and the text d, the labels, and the hierarchical structure (C,E) of the labels that are acquired by the data acquiring section 201. This hierarchical-classification model may be, for example, a zero-shot text classifier which corresponds to the hierarchical structure.

In this manner, the label inferring section 203 may infer a label to be assigned to target data, in accordance with goodness-of-fit scores calculated for the respective labels of a label group having a hierarchical structure. This configuration provides an example effect of making it possible to infer labels having a hierarchical structure, in addition to the example effect produced by the inference apparatus 1 in accordance with the first example embodiment. Further, the label inferring section 203 may use a hierarchical-classification model to calculate goodness-of-fit scores, and an improvement in a label inference accuracy can thus be expected.

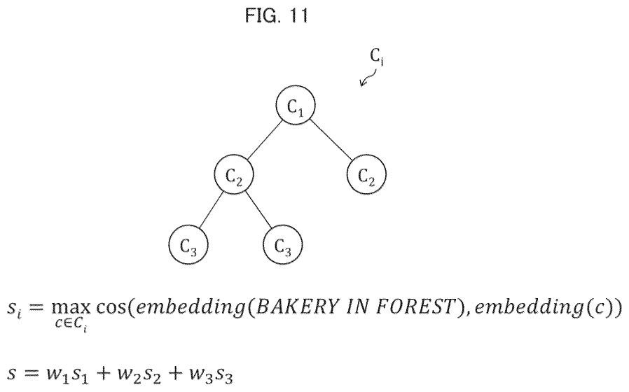

The data converting section 202 may judge, in accordance with the hierarchical structure of the labels, whether to incorporate, into text, column names and elements contained in target data. This will be described on the basis of FIG. 11. FIG. 11 is an explanatory representation of a method for judging, in accordance with the hierarchical structure of labels, whether to incorporate, into the text, column names and elements contained in target data. Note that illustrated in FIG. 11 is an example of judgment on whether to incorporate, into text, an element “BAKERY IN FOREST” contained in the same target data D as in FIG. 10, in a case where a label set Cᵢ having a hierarchical structure is given.

The label set Cᵢ illustrated in FIG. 11 has a hierarchical structure of three levels which are a dominant category C₁, a subcategory C₂, and a further subcategory C₃. In this case, the data converting section 202 vectorizes the element “BAKERY IN FOREST” contained in the target data via a language model and also vectorizes the labels of the label set Cᵢ via the same language model, to calculate cosine similarities between theses vectors.

The data converting section 202 then finds the maximum value sᵢ of the cosine similarities, for each of the categories from the dominant category to the further subcategory, as illustrated in FIG. 11. That is, in a case where there are three levels which are C₁ to C₃, and the numbers of labels are one for C₁, and two for C₂ and C₃, the data converting section 202 finds s₁ from the label of C₁, and also finds s₂ from the two labels of C₂ and finds s₃ from the two labels of C₃, as in the example of FIG. 11.

Next, the data converting section 202 uses a weight w₁ for the dominant category, a weight w₂ for the subcategory, and a weight w₃ for the further subcategory, to calculate a weighted sum s of sᵢ as illustrated in FIG. 11. Given here w₁=1 and w₂=w₃=0, the judgment is made on whether to generate text which contains the element “BAKERY IN FOREST”, in accordance with only the relatedness between the label of the dominant category and the element “BAKERY IN FOREST”. Similarly, given w₃=1 and w₁=w₂=0, the judgment is made on whether to generate text which contains the element “BAKERY IN FOREST”, in accordance with only the relatedness between the labels of the further subcategory and the element “BAKERY IN FOREST”. The values of the weights w₁ to w₃ may be set in advance as fixed values, or may be changed according to the label set, the target data, etc.

Alternatively, the data converting section 202 may determine the values of the weights w₁ to w₃ according to whether a condition set in advance is met. For example, the data converting section 202 may determine w₂=1 in a case where a condition of s₁<θ₁ is met, and determine w₂=0 in a case where this condition is not met. Note that θ₁ is a threshold set in advance for the label of the dominant category. In this case, when a degree to which the label of the dominant category is related to the element “BAKERY IN FOREST” is low (specifically, when the cosine similarity is smaller than the threshold θ₁), the relatedness between the labels of the subcategory and the element “BAKERY IN FOREST” is taken into consideration. Further, in this case, when the label of the dominant category is related to the element “BAKERY IN FOREST” to some degree (specifically, when the cosine similarity is not smaller than the threshold θ₁), the relatedness between the labels of the subcategory and the element “BAKERY IN FOREST” is not taken into consideration.

Thereafter, as in the example of FIG. 10, the data converting section 202 generates text which contains the element “BAKERY IN FOREST” when the calculated s is not smaller than the threshold. For example, the data converting section 202 converts the row e₁, which contains the element “BAKERY IN FOREST”, into text. On the other hand, when the calculated s is smaller than the threshold, the data converting section 202 does not convert the row e₁, which contains the element “BAKERY IN FOREST”, into text. The data converting section 202 may perform such a process on each of the elements of each of the rows.

### (Flow of Processes)

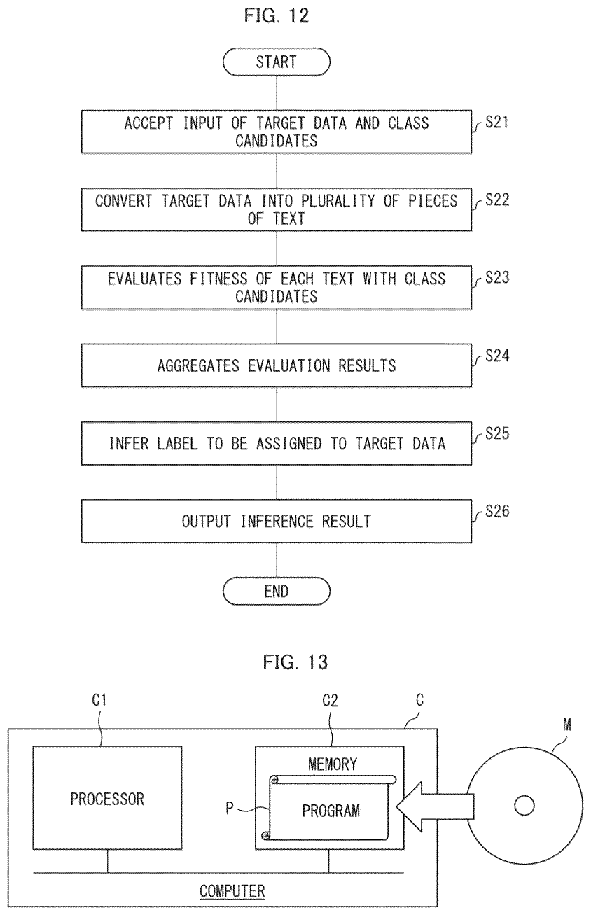

A flow of processes (inference method) carried out by the inference apparatus 2 will be described below on the basis of FIG. 12. FIG. 12 is a flowchart illustrating a flow of processes carried out by the inference apparatus 2. Described here is an example in which a data administrator of a database possessed by a certain enterprise assigns a label to each of the tables of the database with use of the inference apparatus 2. Note that the tables may include tables to which labels have been already assigned, and in a case where the assigned labels are inappropriate, a label reassignment process may be carried out.

In S21, the data acquiring section 201 accepts the input of target data and class candidates. The target data inputted is represented as, for example, D={D₁|1=1, . . . , n}. Note that a single D₁ is a single table (e.g. CSV data). Further, the class candidates are represented as C={cₖ|k=1, . . . , K}. C is a label set which is found, by the data administrator, to be appropriate. The data administrator may input these kinds of data via the input section 22 to the inference apparatus 2.

In S22, the data converting section 202 converts the target data D inputted in S21 into a plurality of pieces of text. As described above, the respective pieces of text may be generated by applying conversion rules 213 different from each other. For example, the data converting section 202 may use the template of “{column name} is {element}” to generate pieces of text from the respective rows of the table and join together the pieces of text, to generate text d_{D}¹, and also use a conversion model such as Table-to-Text to generate text d_{D}². Each of the above template and the conversion model is an example of the conversion rule 213. In a case where L types of conversion rules 213 are used, pieces of text which are d_{D}¹, d_{D}¹, . . . , d_{D}^{L} are generated from the piece of target data D.

In S23, the label inferring section 203 evaluates the fitness of each text with the class candidates. Specifically, the label inferring section 203 carries out, for each of the pieces of text generated in S22, a process of calculating a goodness-of-fit score by inputting the label set inputted in S21 and that piece of text generated in S22 to the label inference model 214 for calculating a goodness-of-fit score. With the processes, a goodness-of-fit score vector set {f(d_{D}¹)} is calculated.

In S24, the label inferring section 203 (score aggregating section) aggregates the results of the evaluation carried out in S23. For example, the label inferring section 203 may calculate the aggregated goodness-of-fit score vector from Expression (1) or (2) described above.

In S25, the label inferring section 203 infers, in accordance with the result of the aggregation carried out in S24, a label to be assigned to the target data D, and stores the label as the inference result 215 in the storage section 21. For example, in S25, the label inferring section 203 may infer the label to be assigned to the target data D with use of Expression (3) or (4) described above.

In S26, the label inferring section 203 outputs the inference result 215 to the output section 23. By carrying out the processes as described above for each of the tables, i.e. the target data, of the database, it is possible to assign appropriate labels to the tables. Note that the process of S26 may be omitted, or may be carried out upon the end of the label inference for all of the pieces of target data contained the database. Further, in a case where the process of S26 is carried out, where to output the inference result is not limited to the output section 23. That is, the label inferring section 203 may output the inference result to another apparatus.

Although the example in which a table, which is structured data, is the target data is described in the above example, the target data may be semi-structured data, or may be unstructured data. In a case where the target data is semi-structured data, the conversion into text may be carried out with use of the conversion rule 213 for semi-structured data in S22. Similarly, in a case where the target data is unstructured data, the conversion into text may be carried out with use of the conversion rule 213 for unstructured data in S22.

Although a plurality of pieces of text are generated from a piece of target data in the above example, a piece of text may be generated from the piece of target data. In this case, the process of S24 is omitted.

### Application Example

The inference apparatus 2 can be used in, for example, integrating databases. Assume, for example, that database possessed by an enterprise A and the database possessed by an enterprise B are to be integrated together, and the labels used by the enterprise A are not used in the enterprise B. In this case, a time and effort-consuming task of manually setting again labels in the database of the enterprise B has conventionally been required. In this respect, with use of the inference apparatus 2, it is possible to quickly automatically set again labels in the database of the enterprise B, simply by inputting to the inference apparatus 2 the label set of labels used by the enterprise A and each of the pieces of target data of the database of the enterprise B.

In addition, in a case where labels are to be redefined in the integration of respective databases of the enterprise A and the enterprise B in the above example, it is possible to quickly automatically set again the labels. In this case, a label set redefined and the pieces of target data of the respective databases of the enterprise A and the enterprise B may be inputted to the inference apparatus 2.

Further, because of the capability of automatically assigning a label even to semi-structured data, the inference apparatus 2 can be used for automatically labeling HTML files which constitute a web page, i.e. automatic classification of a web page. For example, in a case of an enterprise which runs a news site, the inference apparatus 2 can be used for news genre classification. In this case, if adding a new genre of news is desired or if changing an existing genre is desired, the enterprise only needs to define a label set which indicates each of genres provided after the change. Thereafter, the label set and the HTML files of respective pieces of news may be inputted to the inference apparatus 2. This makes it possible to assign, to the HTML file of each of the respective pieces of news, a label which indicates the genre to which that piece of news should belong by the classification.

### [Variation]

A performer which carries out the processes described in the above example embodiments is any performer, and is not limited to the above examples. That is, it is possible to construct an inference system having the same functions as does the inference apparatus 2, with use of a plurality of apparatuses capable of communicating with each other. For example, it is possible to construct an inference system having the same functions as does the inference apparatus 2, by dispersedly providing, in the plurality of apparatuses, respective blocks illustrated in FIG. 4.

### [Software Implementation Example]

Some or all of the functions of the inference apparatus 2 may be implemented by hardware such as an integrated circuit (IC chip), or may be implemented by software. In the latter case, the inference apparatus 2 is implemented by, for example, a computer that executes instructions of a program (inference program) that is software implementing the foregoing functions. An example (hereinafter, computer C) of such a computer is illustrated in FIG. 13. The computer C includes at least one processor C1 and at least one memory C2. The memory C2 has recorded thereon a program P for causing the computer C to operate as the inference apparatus 2. The processor C1 of the computer C retrieves the program P from the memory C2 and executes the program P, so that the functions of the inference apparatus 2 are implemented.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. The storage medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

An inference apparatus including: a data converting means for converting target data subject to label assignment into text; and a label inferring means for inferring a label to be assigned to the target data, in accordance with a label inference model for inferring a label to be assigned to text and the text obtained by the converting carried out by the data converting means.

### (Supplementary Note 2)

The inference apparatus described in supplementary note 1, in which in a case where the target data is semi-structured data, the data converting means is configured to convert the target data into text with use of a predetermined conversion rule for semi-structured data.

### (Supplementary Note 3)

The inference apparatus described in supplementary note 1, in which in a case where the target data is data in a predetermined form, the data converting means is configured to convert the target data into text with use of a conversion model constructed by learning of a correspondence relationship between data in the predetermined form and text which indicates content of the data in the predetermined form.

### (Supplementary Note 4)

The inference apparatus described in any one of supplementary notes 1 to 3, in which the data converting means is capable of converting the target data into text with respect to a plurality of forms taken by the target data.

### (Supplementary Note 5)

The inference apparatus described in any one of supplementary notes 1 to 4, in which in a case where the data converting means converts a piece of target data into a plurality of pieces of text, the piece of target data being subject to label assignment, the label inferring means is configured to infer the label to be assigned to the piece of target data, in accordance with respective output values obtained by inputting the plurality of pieces of text into the label inference model.

### (Supplementary Note 6)

The inference apparatus described in any one of supplementary notes 1 to 5, in which the data converting means is configured to determine, from among character strings contained in the target data, one or more character strings related to the label, and convert the target data into text which contains the one or more character strings determined.

### (Supplementary Note 7)

The inference apparatus described in any one of supplementary notes 1 to 6, in which the label inferring means is configured to infer the label to be assigned to the target data, in accordance with a numerical value calculated with use of a language understanding model constructed by learning of whether a premise sentence entails a hypothesis sentence, the numerical value indicating a degree to which the text entails a hypothesis sentence related to the label.

### (Supplementary Note 8)

The inference apparatus described in any one of supplementary notes 1 to 7, in which the label inferring means is configured to infer the label to be assigned to the target data, in accordance with an output value calculated for each of labels contained in a label group having a hierarchical structure.

### (Supplementary Note 9)

An inference method including: at least one processor converting target data subject to label assignment into text; and the at least one processor inferring a label to be assigned to the target data, in accordance with a label inference model for inferring a label to be assigned to text and the text obtained by the converting.

### (Supplementary Note 10)

An inference program for causing a computer to function as: a data converting means for converting target data subject to label assignment into text; and a label inferring means for inferring a label to be assigned to the target data, in accordance with a label inference model for inferring a label to be assigned to text and the text obtained by the converting carried out by the data converting means.

### [Additional Remark 3]

The whole or part of the example embodiments disclosed above can be described as follows. An inference apparatus including at least one processor, the at least one processor carrying out: a data converting process of converting target data subject to label assignment into text; and a label inferring process of inferring a label to be assigned to the target data, in accordance with an output value obtained by inputting, to a label inference model for inferring a label to be assigned to text, the text obtained by the converting carried out in the data converting process.

This inference apparatus may further include a memory, and this memory may have stored therein a program for causing the at least one processor to carry out the data converting process and the label inferring process. This program may be stored in a computer-readable, non-transitory, and tangible recording medium.

### REFERENCE SIGNS LIST

1, 2: Inference apparatus
11, 202: Data converting section
12, 203: Label inferring section

What is claimed is:

1. An inference apparatus comprising at least one processor, the processor carrying out:
a data converting process of converting target data subject to label assignment into text; and
a label inferring process of inferring a label to be assigned to the target data, in accordance with a label inference model for inferring a label to be assigned to text and the text obtained by the converting carried out in the data converting process.

2. The inference apparatus according to claim 1, wherein
in a case where the target data is semi-structured data, in the data converting process, the processor converts the target data into text with use of a predetermined conversion rule for semi-structured data.

3. The inference apparatus according to claim 1, wherein
in a case where the target data is data in a predetermined form, in the data converting process, the processor converts the target data into text with use of a conversion model constructed by learning of a correspondence relationship between data in the predetermined form and text which indicates content of the data in the predetermined form.

4. The inference apparatus according to claim 1, wherein
in the data converting process, the processor can convert the target data into text with respect to a plurality of forms taken by the target data.

5. The inference apparatus according to claim 1, wherein
in a case where the data converting process converts a piece of target data into a plurality of pieces of text, the piece of target data being subject to label assignment, in the label inferring process, the processor infers the label to be assigned to the piece of target data, in accordance with respective output values obtained by inputting the plurality of pieces of text into the label inference model.

6. The inference apparatus according to claim 1, wherein
in the data converting process, the processor determines, from among character strings contained in the target data, one or more character strings related to the label, and converts the target data into text which contains the one or more character strings determined.

7. The inference apparatus according to claim 1, wherein
in the label inferring process, the processor infers the label to be assigned to the target data, in accordance with a numerical value calculated with use of a language understanding model constructed by learning of whether a premise sentence entails a hypothesis sentence, the numerical value indicating a degree to which the text entails a hypothesis sentence related to the label.

8. The inference apparatus according to claim 1, wherein
in the label inferring process, the processor infers the label to be assigned to the target data, in accordance with an output value obtained for each of labels contained in a label group having a hierarchical structure, by inputting, to the label inference model, the text obtained by the converting carried out in the data converting process.

9. An inference method comprising:
at least one processor converting target data subject to label assignment into text; and
the at least one processor inferring a label to be assigned to the target data, in accordance with a label inference model for inferring a label to be assigned to text and the text obtained by the converting.

10. A non-transitory storage medium storing an inference program for causing a computer to carry out:
a data converting process of converting target data subject to label assignment into text; and
a label inferring process of inferring a label to be assigned to the target data, in accordance with a label inference model for inferring a label to be assigned to text and the text obtained by the converting carried out in the data converting process.
